(19) United States
(12) Patent Application Publication
(10) Pub. No.: US 2025/0207434 A1
(43) Pub. Date: Jun. 26, 2025

(54) ELECTRIC LOCKING UNIT

(71) Applicant: Astra Gesellschaft für Asset Management mbH & Co. KG, Barsinghausen (DE)

(72) Inventors: Anatoli Stobbe, Barsinghausen (DE); Klaus Göppert-Boenke, Bad Salzdetfurth (JP); Dieter Neuhold, Gera (DE)

(73) Assignee: Astra Gesellschaft für Asset Management mbH & Co. KG, Barsinghausen (DE)

(21) Appl. No.: 18/985,641

(22) Filed: Dec. 18, 2024

(30) Foreign Application Priority Data
Dec. 22, 2023 (DE) 102023136459.6

(51) Int. Cl. E05B 47/06; E05B 15/04

(52) U.S. Cl. CPC E05B 47/068; E05B 15/04; E05B 2015/0413

(57) ABSTRACT

An electric locking unit comprising a coupling device is described, the coupling device comprising an electric motor, a spring member, and a coupling member, the electric motor comprising a worm shaft with a helical winding. The coupling member is mounted axially slidably in the direction of extension of the worm shaft and has a contour configured for mechanically couple with a locking member. The spring member is connected, at a distal end portion, to the coupling member and, at an opposite proximal end portion, is axially slidably coupled with the worm shaft of the electric motor to convert a rotation of the worm shaft into a linear motion of the proximal end portion of the spring member. The worm shaft is idling when the spring member that is compressed or extended into a bias position reaches one of the two end position of the locking cylinder in the coupled or decoupled state. The proximal end portion of the spring member has a reduced diameter over at least one winding wrap over the worm shaft, such that the spring member is able to engage with the worm shaft via this at least one winding wrap.

### FIELD OF THE INVENTION

The invention relates to an electric locking unit comprising a coupling device, the coupling device comprising an electric motor, a spring member, and a coupling member, the electric motor having a worm shaft with a helical winding, wherein the coupling member is mounted axially slidably in the direction of extension of the worm shaft and has a contour configured to mechanically couple with a locking member, and wherein the spring member is connected, at a distal end portion, to the coupling member and, at an opposite proximal end portion, is axially slidably coupled with the worm shaft of the electric motor to convert a rotation of the worm shaft into a linear motion of the proximal end portion of the spring member, wherein the worm shaft is idling when the spring member that is compressed or extended into a bias position reaches one of the two end position of the locking cylinder in the coupled or decoupled state.

### BACKGROUND OF THE INVENTION

EP 1 576 246 B1 discloses such a locking device for a lock system for actuating a locking cylinder of a lock by rotating a key or a door knob. Therein, a coupling element and an electronically controlled drive means connected to the housing and drive means for moving the coupling element are provided. In its second coupling state, where an output member is coupling with the rotor, the coupling element may be moved away from the drive means by way of a rotational movement of the rotor. This ensures that the coupling occurs only in a single singular state and reduces the probability that the coupling member will enter into the second coupling state by random excitations. This is achieved by means of a coupling member that is mounted such that it may be rotated radially to the direction of extension of the rotor.

EP 1 522 658 B1 discloses an electric lock where a slider is linearly displaceable by means of a spring member. An end portion of the spring member engages with the spindle shaft of an electric motor, in order to displace the slider coupled with the spring member when the spindle shaft rotates.

WO 98/15703 A1 describes an electromechanical lock having an electric motor with a shaft that is connected to a compression spring. This compression spring forms a flexible shaft that is connected, at its distal end, to a knob shaft. A pin of an axially displaceable coupling member engages with a worm shaft of a helical wire at the knob shaft for axially displacing a coupling member.

EP 2 927 395 A1 discloses a locking cylinder including a coupling assembly, where a slide element engages with a worm shaft for converting a rotational movement of the worm shaft into an axial movement of the slide element with respect to the switching axis. A coupling device is displaceable by means of a drive device via the slide element parallel to the switching axis. The slide element is biased by means of two spring members in both axial directions.

DE 10 2019 113 666 B4 discloses a locking cylinder including a cylinder housing, a cylinder cam rotatably mounted in the cylinder housing, a knob shaft rotatably mounted in the cylinder housing, a coupling device in the knob shaft for mechanically coupling the knob shaft with the cylinder cam and with drive electronics that is connected to the coupling device for electronically coupling and decoupling the knob shaft and the cylinder cam with the coupling device, wherein the coupling device includes an electric motor having a shaft, a spring element and a coupling member, wherein the coupling member is mounted to the knob shaft such that it is axially displaceable along the direction of extension of the knob shaft and has a contour configured to mechanically couple with the cylinder cam, and that the spring element is connected, at a distal end portion, to the coupling member, and at an opposing proximal end portion to the shaft of the electric motor, in order to convert a rotation of the shaft into a linear movement of the proximal end portion of the spring element.

### SUMMARY OF THE INVENTION

The present invention provides an improved electric locking unit that ensures improved interaction of components for reliable operation and at the same time easy installation in a simple and compact design.

It is proposed that the proximal end portion of the spring member has a reduced diameter over at least one turn of the worm shaft, such that the spring member is able to engage with the worm shaft via this at least one turn.

This improves the coupling of the spring member with the worm shaft, and in particular the engagement of the proximal end from the idling state to the coupled state. It reduces the risk of twisting and the transition from the decoupled to the coupled state is smoothened. Additionally, the improved threading makes it very easy to reliably mount the spring member onto the worm shaft. For idling, the angle of more than 320°, that is, at least one single turn, is limited to a maximum angle that allows receiving the portion of the spring member axially adjacent to the helical winding of the worm shaft. The turns should preferably not exceed 3 turns, that is, an angle of 960°.

The worm shaft may be idling, when one of the two end positions of the locking unit is reached in the coupled or decoupled state, respectively. The worm shaft is idling, when
in its end position displaced away from the locking member, the coupling member is decoupled;
in its end position displaced into the coupling contour of the locking member, the coupling member is coupled;
the coupling member has reached a hard stop at the locking member, but does not couple with the coupling contour of the locking member, whereby the spring member is compressed and functions as an energy store;
the coupling member is clamped at the coupling contour of the locking member while retracting back into the decoupled end position and is thereby prevented from decoupling, whereby the spring member is compressed and functions as an energy store.

Thereby, the spring member is compressed or stretched into a bias position.

Preferably, the proximal end portion of the spring member has a reduced diameter over 1.5 turns to 2 turns of the worm shaft, such that the spring member may engage with these 1.5 turns to 2 turns of the worm shaft. However, more turns, for example 2 turns to 3 turns are contemplated, that is, an angle of 640° to 960, but not turns across the entire length of the helical winding of the worm shaft.

The coupling member may have a polygonal outer contour. Thereby, the coupling member is mounted in a rotationally fixed and axially displaceable manner. The form fit of the outer contour of the coupling member is distributed across the outer circumference due to the polygonal shape and is not limited to angular guiding regions. The risk of twisting the coupling member while mounted, for example, in a coupling shaft, is thus reduced. This ensures low frictional resistance for axial displacement.

A cylindrical outer contour of the coupling member is advantageous, whereby at least one protrusion protrudes from the outer circumference of the cylinder. Here, at least one cuboid protrusion is disposed on the outer circumference of the cylindrical outer contour for dipping into a correspondingly contoured latching recess and mechanically coupling in a form-fitting manner therein.

To this end, a pair of cuboid protrusions at the outer circumference of the cylindrical outer contour of the coupling member may protrude in opposite directions from one another from the outer circumference.

The coupling member may include a spring retaining core and a coupling element, whereby the coupling element includes a receiving opening for receiving the spring retaining core pressed into the receiving opening in a press-fitting manner. The spring retaining core may include a support portion protruding towards the worm shaft. The distal end of the spring member loops around the support portion with at least two turns and is frictionally connected to the support portion. This achieves a reliable frictional connection of the spring member to the coupling member.

The coupling member may have a receiving opening for receiving the distal end of the spring member, which abuts against a tubular wall delimiting the receiving opening. The coupling member may include at least one deformation region, where a tubular wall deformation region is deformed into the interior space of the receiving opening. In this manner, the distal end of the spring member received in the receiving opening is form-fittingly connected to the coupling member at the deformation region protruding into the interior space of the receiving opening. The installation with stable connection of the spring member to the coupling member is effected simply by a deformation of the coupling member at the at least one deformation region after inserting the spring member into the receiving opening.

The distal end of the spring member may abut against the end face delimiting the receiving opening, whereby at least two turns of the distal end of the spring member are arranged between the end face and the deformation region.

The spring member is preferably a compression spring, that is, a helical spring, that expands in the direction of extension due to its resilience and may be compressed against the spring force.

The electric locking unit may be embodied as a locking cylinder including a cylinder housing, a cylinder cam rotatably mounted in the cylinder housing, and a knob shaft rotatably mounted in the cylinder housing. The coupling device is configured within the knob shaft for mechanically coupling the knob shaft with the cylinder cam. Drive electronics is connected to the coupling device for electronically coupling and decoupling the knob shaft and the cylinder cam. Such a locking cylinder with a simple and robust design may be inserted into a lock, for example, a door lock, in order to open or close said lock via the cylinder cam. To this end, the cylinder cam is rotated at the knob shaft, when the cylinder cam is coupled to the knob shaft in the coupled state.

The object of the invention is also achieved by means of an electric locking unit in the form of a locking cylinder that includes a cylinder housing, a cylinder cam rotatably mounted in the cylinder housing, a knob shaft rotatably mounted in the cylinder housing, and a coupling device. The coupling device is disposed within the knob shaft and configured to mechanically couple the knob shaft with the cylinder cam. The coupling device comprises an electric motor, a spring member, and a coupling member, the electric motor having a worm shaft with a helical winding. The coupling member is mounted axially slidably in the direction of extension of the worm shaft and has a contour configured to mechanically couple with a locking member. The spring member is connected, at a distal end portion, to the coupling member and, at an opposite proximal end portion, is axially slidably coupled with the worm shaft of the electric motor to convert a rotation of the worm shaft into a linear motion of the proximal end portion of the spring member, wherein the worm shaft is idling when one of the two end positions of the locking cylinder in the coupled or decoupled state is reached. The worm shaft may also idle when the coupling member has reached a hard stop at the locking member without being coupled, whereby the spring member is compressed and functions as an energy store, or is clamped at the locking member while being decoupled, whereby the spring member is expanded and functions as an energy store.

It is proposed that the coupling member has a polygonal outer contour.

Thereby, the coupling member is mounted in a rotationally fixed and axially displaceable manner. The form fit of the outer contour of the coupling member is distributed across the outer circumference due to the polygonal shape and is not limited to angular guiding regions. The risk of twisting the coupling member while mounted, for example, in a coupling shaft, is thus reduced. This ensures low frictional resistance for axial displacement.

A drilling protection member may be disposed in the knob shaft on the side of the electric motor that is opposite the shaft. This counteracts sabotage by drilling from the side of the electric locking unit, in particular of the locking cylinder, that is located on the unsecured outside.

The electric locking unit may preferably include drive electronics that is integrated into the locking unit, connected to the electric motor, and configured to electronically couple and decouple the coupling member. Optionally, the drive electronics may also be located outside of the electric locking unit and coupled to the electric motor in a wired or wireless fashion.

### BRIEF DESCRIPTION OF THE DRAWINGS

The invention will be explained in more detail below by means of an exemplary embodiment together with the accompanying drawings. In these:

FIG. 1—illustrates a sectional side view of a locking cylinder in the decoupled state;

FIG. 2—illustrates a side cutout view of the locking cylinder of FIG. 1 in the region of the coupling device;

FIG. 3—illustrates a sectional side view of a locking cylinder with a biased spring member;

FIG. 4—illustrates a side cutout view of the locking cylinder of FIG. 3 in the region of the coupling device;

FIG. 5—illustrates a sectional side view of a locking cylinder in the coupled state;

FIG. 6—illustrates a side cutout view of the locking cylinder of FIG. 5 in the region of the coupling device;

FIG. 7—illustrates a front view of the polygonal coupling member;

FIG. 8—illustrates a sectional side view of the coupling member including a spring retaining core and a coupling element and a spring member frictionally connected to a support portion of the spring retaining core;

FIG. 9—illustrates a side view of the coupling member of FIG. 8;

FIG. 10—illustrates a side view of another embodiment of a coupling member with a spring member connected thereto;

FIG. 11—illustrates a sectional side view of the coupling member of FIG. 10 having deformation regions;

FIG. 12—illustrates a side cutout view of the coupling member of FIG. 11 in the area of a deformation region with the spring member form-fittingly connected thereto;

FIG. 13—illustrates a perspective view of a cylindrical coupling member with a pair of cuboid protrusions;

FIG. 14—illustrates a front view of the cylindrical coupling member of FIG. 13;

FIG. 15—illustrates a side view of the coupling member of FIG. 13 including a spring retaining core and a coupling element and a spring member frictionally connected to a support portion of the spring retaining core;

FIG. 16—illustrates a sectional side view of the coupling member of FIG. 15;

FIG. 17—illustrates a side cutout view of the coupling member of FIG. 16 in the area of a deformation region with the form-fittingly connected spring member.

### DETAILED DESCRIPTION OF THE INVENTION

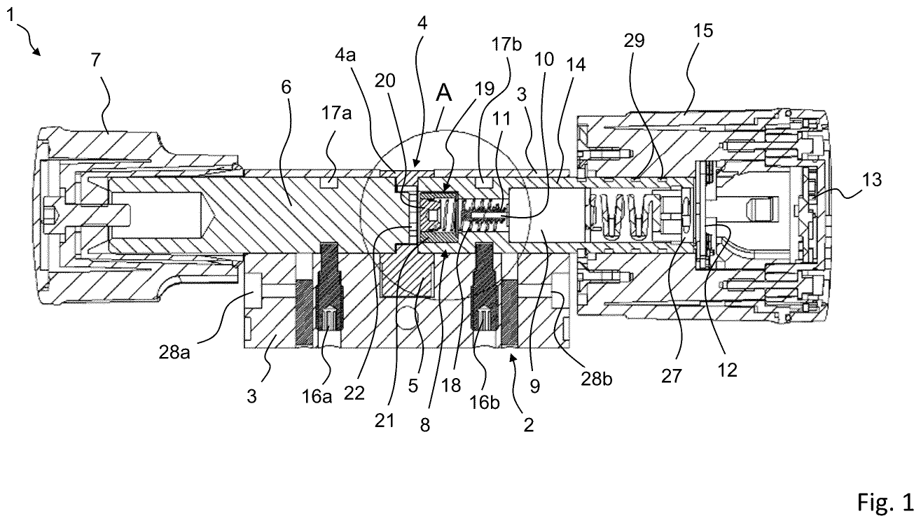

FIG. 1 illustrates a sectional side view of electric locking unit 1 in the form of locking cylinder 2 for a lock (not shown) in the decoupled state.

Locking cylinder 2 includes cylinder housing 3, where locking member 4 in the form of cylinder cam 4a is rotatably supported. Cylinder cam 4a includes dog 5 protruding from the axis of rotation of cylinder cam 4a in the usual manner for actuating a latch of a lock when locking cylinder 2 is installed in a lock.

Furthermore, knob shaft 6 is rotatably mounted within cylinder housing 3. Operating knob 7 may be attached to the end of knob shaft 6 protruding from cylinder housing 3.

Coupling device 8 is installed in knob shaft 6 for mechanically coupling knob shaft 6 with cylinder cam 4a. Coupling device 8 includes electric motor 9 with shaft 10, onto which worm shaft 11 is mounted in a press-fitting manner. However, worm shaft 11 may also be formed integrally with shaft 10 of electric motor 9. Worm shaft 11 includes a thread ridge winding in the direction of extension of worm shaft 11 circumferentially around worm shaft 11, that is, a helical thread.

Electric motor 9 is driven by means of drive electronics 12. Drive electronics 12 may preferably include radio signal receiver 13 for wirelessly receiving opening and closing signals. Radio signal receiver 13 may be configured for near field (NFC, e.g. RFID) and/or far field reception (e.g. Bluetooth, ZigBee, WiFi).

Coupling device 8 is installed in knob shaft 14 in a rotationally fixed manner. Operating knob 15 is rotationally affixed onto knob shaft 14. Knob shafts 6, 14 are each installed in a flush hole of cylinder housing 3, respectively, and each form-fittingly secured with lock screws 16a, 16b, respectively, against axial displacement. Knob shafts 6, 14 each have circumferential grooves 17a, 17b at their outer circumference, respectively, into which respective lock screws 16a, 16b are dipped without any force acting in a radial direction against each of respective knob shafts 6, 14. This ensures that knob shafts 6, 14 are mounted in cylinder housing 3 such that they may be rotated about their axes.

Coupling device 8 includes spring member 18 in the form of a helical spring (e.g. a compression spring). The proximal end portion of spring member 18 closest to electric motor 9 may be engaged with at least a single turn of worm shaft 11, such as to cause an axial displacement upon a rotation of worm shaft 11.

In the illustrated example embodiment, the distal end of spring member 18 is connected to coupling member 19 in a rotationally fixed manner. Coupling member 19 includes spring retaining core 20 and coupling element 21. Spring retaining core 20 is press-fittingly received in a receiving opening of coupling element 21. The distal end of spring member 18 encloses spring retaining core 20 and is form-fittingly and frictionally mounted between spring member 20 and the inner wall of coupling element 21 surrounding spring retaining core 20. Thereby, the distal end of spring member 18 is connected to coupling member 19.

Coupling member 19 is mounted in knob shaft 14 in an axially displaceable manner and has an outer contour that, together with an inner wall contour of knob shaft 14, forms a stop for preventing a rotation of coupling member 19 in the interior space of knob shaft 14. To this end, the outer contour of coupling element 21 may, for example, be polygonal. The inner wall of knob shaft 14 has a corresponding polygonal cross section in the portion, where coupling member 19 is received.

Proximal end portion 26 of the spring member that is opposite coupling member 19, with at least one turn at the outer end, preferably with at least turns in the range of 360° to 720° (one or two turns), and particularly preferably from about 500° to 700°, has a diameter that is reduced compared to the subsequent portion, through which diameter proximal end portion 26 enters into the space between the helical windings of worm shaft 11 and thus engages with the thread ridges of worm shaft 11.

Thereby, proximal end portion 26 of spring member 18 may be guided into the space of the helical winding of worm shaft 8, in order to tension or release spring member 18 with a rotation of worm shaft 8 and thereby move coupling member 19 back and forth axially along the longitudinal axis of knob shaft 14. The coupling of proximal end portion 26 of spring member 18 with worm shaft 11 causes spring member 18 to be tensioned or released and coupling member 19 is moved at the distal end of spring member 18 into the direction of the interior space of knob shaft 14 or moved out of the end-face opening of knob shaft 14 for coupling with cylinder cam 4a.

In the illustrated decoupled state, coupling member 19 is largely received in the interior space of knob shaft 14 and spaced apart from coupling contour 22 of locking member 4.

The coupled state is reached at the latest when coupling member 19 protrudes maximally from the knob shaft 14 at the end face and is thereby form-fittingly connected to coupling contour 22 of locking member 4 and cylinder cam 4a, respectively.

In the decoupled sate, proximal end portion 26 of spring member 19 is idling and is not engaged with worm shaft 11. The at least one turn is disposed behind the helical winding on a tubular portion of worm shaft 11, located between the end face of electric motor 9 and the start of the helical winding.

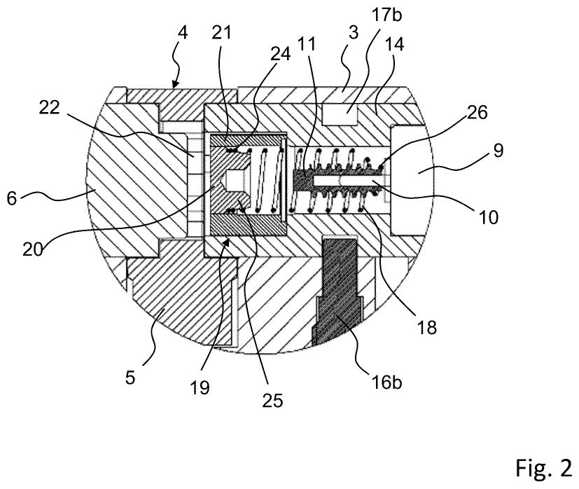

FIG. 2 illustrates a side cutout view of locking cylinder 2 of FIG. 1 in the region of coupling device 8.

In the illustrated example embodiment, coupling member 19 is embodied in multiple parts so as to ease the assembly. It includes polygonal coupling element 21 with receiving opening 23, in which spring retaining core 20 is received. The connection between spring retaining core 20 and the coupling element 21 may be facilitated by press fit. However, material bonding, e.g. by welding, or a form-fitting and, if applicable, frictional connection by means of screwing, pinning or riveting is also contemplated. It is also contemplated, however, that coupling element 21 is integrally formed with spring retaining core 20.

Distal end portion 24 of the spring member loops around support portion 25 protruding into receiving opening 23 of coupling element 21 towards electric motor 9 with at least one turn, preferably with more than two turns, that is, with a turning angle of more than 720°. Distal end 24 is thereby frictionally stretched onto support portion 25 and form-fittingly received in the space between support portion 25 and the inner wall of coupling element 21 delimiting receiving opening 23.

In the illustrated decoupled state, proximal end 26 of spring member 18 opposite coupling member 19 is in an idling state, without engaging with the helical winding of worm shaft 11. Proximal end portion 26 with its reduced diameter is positioned between the start of the helical winding of worm shaft 11 and the end face of electric motor 9.

It can be seen that the diameter of the portion of spring member 18 that adjoins proximal end portion 26 and extends to distal end portion 24 is larger than the outer diameter of the helical winding of worm shaft 11. Thus, spring member 18 engages form-fittingly with the helical winding of worm shaft 11 only in the region of proximal end portion 26.

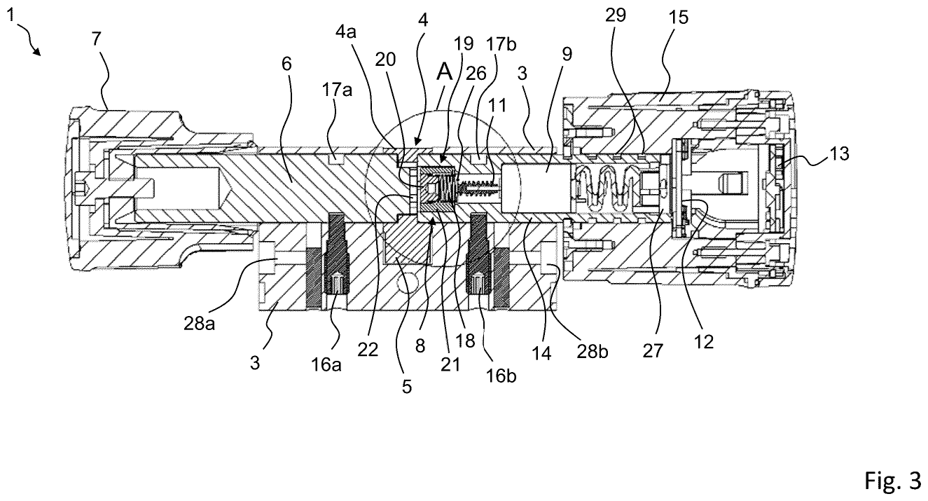

FIG. 3 illustrates a sectional side view of locking cylinder 2 with biased spring member 18.

The coupling contour of coupling member 19 is not yet accurately aligned with corresponding coupling contour 22 of locking member 4. Therefore, coupling member 19 is not yet axially displaced to such an extent that it engages with locking member 4. However, spring member 18 is already biased by moving proximal end portion 26 away from electric motor 9 and towards coupling member 19 by rotating worm shaft 11. Thereto, the turns of spring member 18 positioned between the helical thread flank are axially displaced.

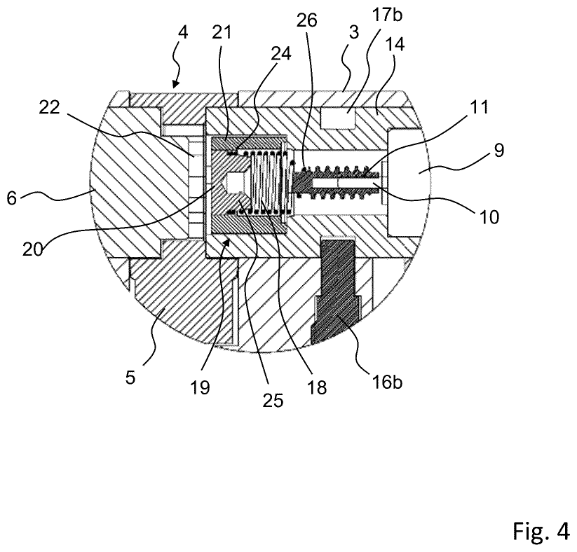

FIG. 4 illustrates a side cutout view of locking cylinder 2 of FIG. 3 in the region of coupling device 8 in the biased state.

In the illustrated end position, worm shaft 11 is again idling, because at the end of the helical winding, proximal end portion 26 is again free from engagement with the thread flanks of this helical winding and is disposed between the end of the helical winding and coupling member 19 on a tubular end portion of worm shaft 11.

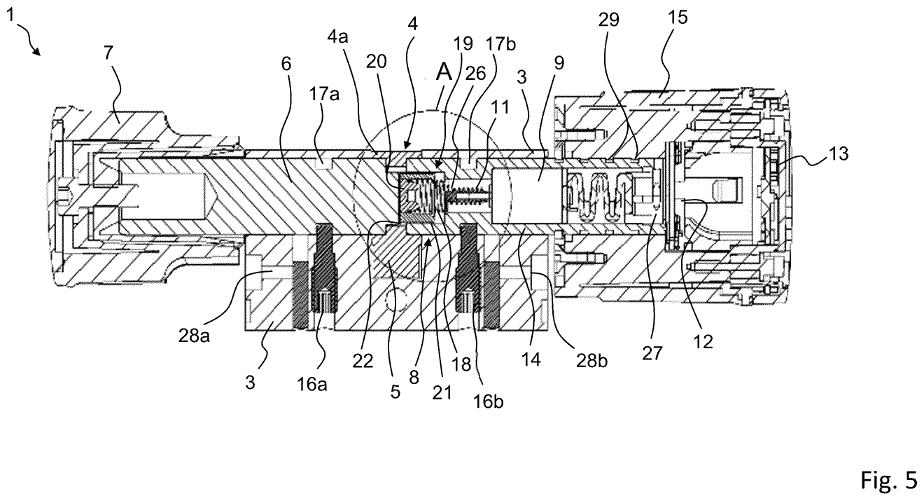

FIG. 5 illustrates a sectional side view of locking cylinder 2 in the coupled state. At this point, the coupling contour of coupling member 19 is oriented due to the relative rotation of knob shafts 6, 14 with respect to each other, such that said contour is aligned with corresponding coupling contour 22 of locking member 4. Hereby, polygonal coupling member 19 may dip into a corresponding polygonal recess in cylinder cam 4a. This causes a form fit between coupling member 19 and locking member 4.

In the two coupled and decoupled end positions, shown in FIGS. 1 and 5, spring member 18 is no longer engaged with worm shaft 11. In particular, worm shaft 11 is idling, when one of the end positions is reached and electric motor 9 continues to rotate. This ensures a defined pressing force of spring member 18. In addition, it reduces the power consumption in the idle state. Further, it prevents an excessive load on spring member 18. The end positions may simplify the temperature compensation. At lower temperatures, the movement is sluggish, such that electric motor 9 must be operated for a longer time than at higher temperatures. The runtime of electric motor 9 does not need to be adjusted—or does not need to be adjusted so accurately—because of the idling in the end positions.

It can also be seen that drilling protection member 27 is disposed within the knob shaft 14 at the side of knob shaft 14 facing away from coupling device 8. Drilling protection member 27 separates the unprotected side facing towards operating knob 15 from the unprotected side of locking cylinder 2, located behind drilling protection member 27 as viewed from operating knob 15, the side where coupling device 8 is located.

For adjusting the length of locking cylinder 2 to a respective door leaf thickness, cylinder housing 3 may optionally be expanded by means of extension plates that are screwed onto the end face adjacent to operating knob 7, 15. To this end, cylinder housing 3 includes threaded bores 28a, 28b for receiving attachment screws for the extension plates.

Operating knob 15 may be fixed at multiple positions onto knob shaft 14. To this end, knob shaft 14 is provided with latching grooves 29 at predetermined latching positions.

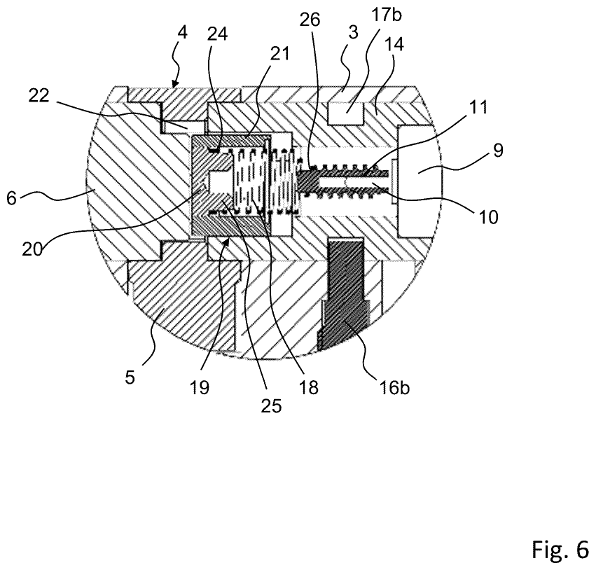

FIG. 6 illustrates a side cutout view of locking cylinder 2 of FIG. 5 in the region of coupling device 8.

It can be seen that coupling member 19 has now moved away from electric motor 9 into the recess in locking member 4 due to the spring pressure of spring member 18. Worm shaft 11 is still idling, because proximal end portion 26 of spring member 18 is not engaged with the helical winding of worm shaft 11.

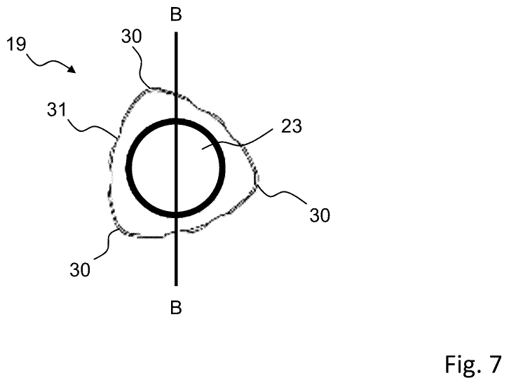

FIG. 7 illustrates a front view of the polygonal coupling element 21 across cut B-B.

Coupling element 21 has a central receiving opening 23, in which spring retaining core 20 is installed. The outer circumference has a polygonal contour with, e.g., three protruding bumps 30. Additional troughs 32 may optionally be present at intermediate regions 31 that have reduced diameters.

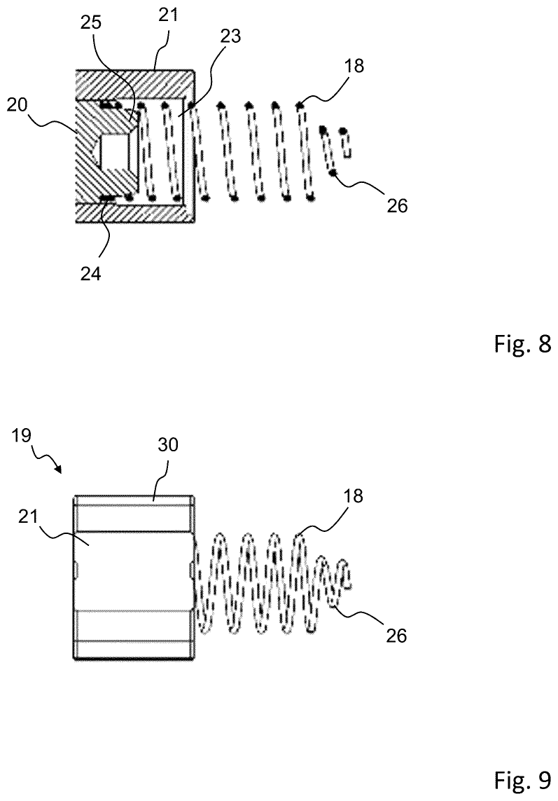

FIG. 8 illustrates a sectional side view along cut B-B of coupling member 19 including spring retaining core 20 and coupling element 21 and spring member 18 frictionally connected to support portion 25 of spring retaining core 20.

It can be seen that the diameter of spring member 18 is significantly reduced in proximal end region 26 over more than one turn, that is, more than 360°. In the illustrated example embodiment, proximal end region 26 extends over about 400° to 540°, that is, over more than one turn to 1.5 turns.

Furthermore, it is apparent that distal end portion 24 is frictionally connected to support portion 25 of spring retaining core 20 with more than two windings. Additionally, distal end portion 24 may abut against an end face of spring retaining core 20.

Spring retaining core 20 is received in receiving opening 23 and pressed against coupling element 21. However, it is also contemplated that coupling element 21 has a female thread and spring retaining core 20 has a corresponding male thread and spring retaining core 20 is screwed into coupling element 21. Other types of attaching spring retaining core 20 to coupling element 21 are also contemplated.

FIG. 9 illustrates a side view of the coupling member 19 of FIG. 8 with the spring member 18 installed.

The polygonal outer contour of coupling element 21 is visible.

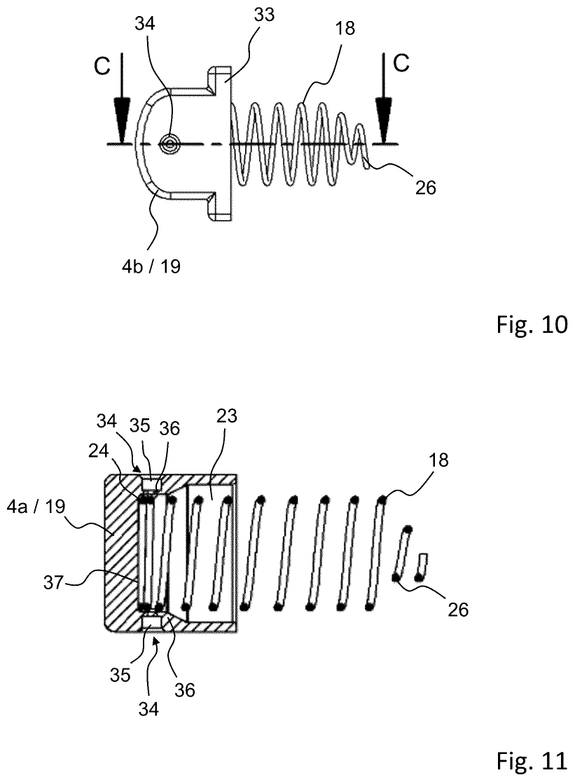

FIG. 10 illustrates a side view along cut C-C of another embodiment of coupling member 19 with spring member 18 connected thereto.

This embodiment is suitable for electric locking unit 1, which is utilized, for example, without rotatable knob shaft 6, 14 by linear displacement of pressure member 4b which at least forms part of the locking member 4 in an armature, for example, in a furniture lock. Coupling member 19 may be used directly as a latch of a lock and thereby embody locking member 4.

Pressure member 4b includes protruding lugs 33 that are received in a guide hole for supporting pressure member 4b in a linear displaceable but rotationally fixed manner. Spring member 18 is received in receiving opening 23 of pressure member 4b.

Deformation regions 34 are located on pressure member 4b that provide a form-fitting connection of spring member 18 to pressure member 4b by deformation.

FIG. 11 illustrates a sectional side view of coupling member 19 of FIG. 10 along cut C-C with opposing deformation regions 34. Deformation regions 34 include a blind hole 35, into which distal end portion 24 of spring member 18 may be forcedly fixed into place at the blind hole peripheral regions. To this end, a post is inserted into blind holes 35 which deforms inner wall 36 of coupling member 19 adjacent to distal end portion 24.

This type of attachment of spring member 18 to coupling member 19 may also be employed in the first example embodiment in a corresponding manner. Thus, polygonal coupling member 19 may have blind holes 35 at its outer circumference, which attach distal end portion 24 to coupling member 19 by deforming inner walls 36, which delimit blind holes 35.

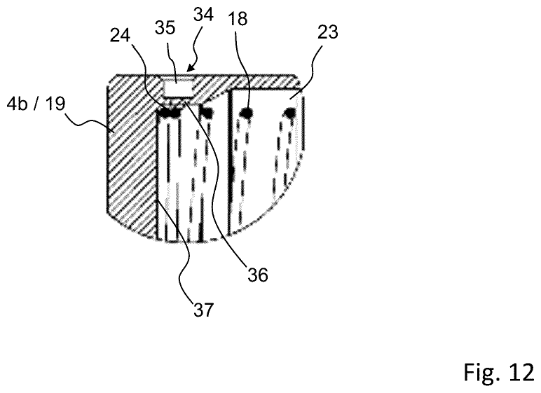

FIG. 12 illustrates a side cutout view of coupling member 19 of FIG. 11 in the area of deformation region 34 with spring member 18 form-fittingly connected thereto.

It can be seen that inner wall 36 of blind hole 35 is deformed into receiving opening 23 of coupling member 19, in order to compress the outer diameter of the windings of spring member 18 at distal end portion 24 and thereby form-fittingly and frictionally receive distal end portion 24 within the interior space of coupling member 19.

In order to allow simplified assembly without limiting the mobility of the main portion of spring member 18 adjacent to distal end portion 24, the diameter of receiving opening 23 in front of the portion with deformation regions 34 may expand conically.

Distal end portion 24 of spring member 18 may abut against end face 37 in the interior space of coupling member 19.

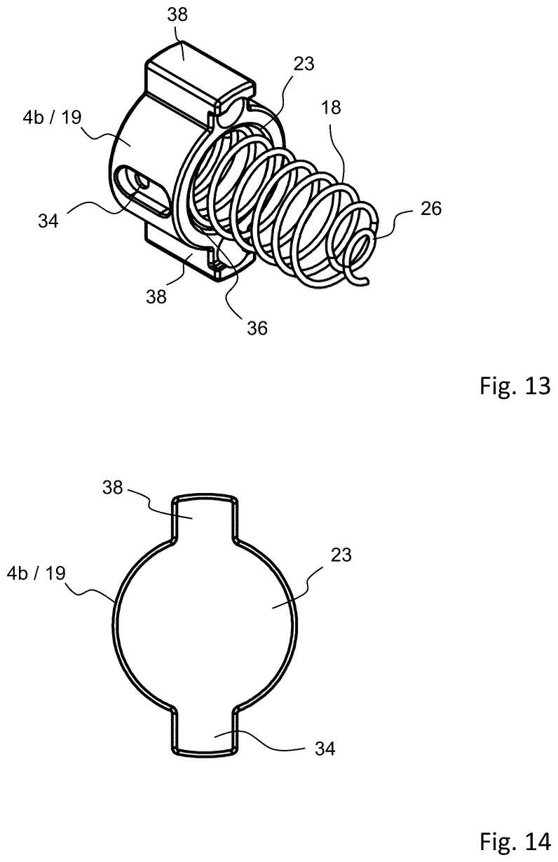

FIG. 13 illustrates a perspective view of cylindrical coupling member 19 including a pair of cuboid protrusions 38 at the outer circumference of the cylindrical base.

Coupling member 19 has a central receiving opening 23, in which spring member 18 is installed. At the outer circumference there is at least one deformation region 34 with recess 39. Blind hole 35 within recess 39 may be deformed into the interior space of coupling member 19, in order to form-fittingly affix distal end 24 of spring member 18 to coupling member 19.

Cuboid protrusions 38 protruding in opposite directions from the outer circumference of the cylindrical base may dip into correspondingly contoured receiving openings of coupling contour 22 when properly aligned, in order to couple coupling member 19 with knob shaft 6. This causes a form fit between knob shaft 6 and coupling member 19. The symmetric arrangement of protrusions 38 allows the coupling in two positions of knob shaft 6 and coupling member 19 that are rotated by an angle of 180° with respect to each other.

FIG. 14 illustrates a front view of cylindrical coupling member 19 of FIG. 13.

It can be seen that a pair of cuboid protrusions 38 protrude in opposite directions from the cylindrical outer contour of the base. Protrusions 38 may have chamfered edges and a slightly curved radial surface.

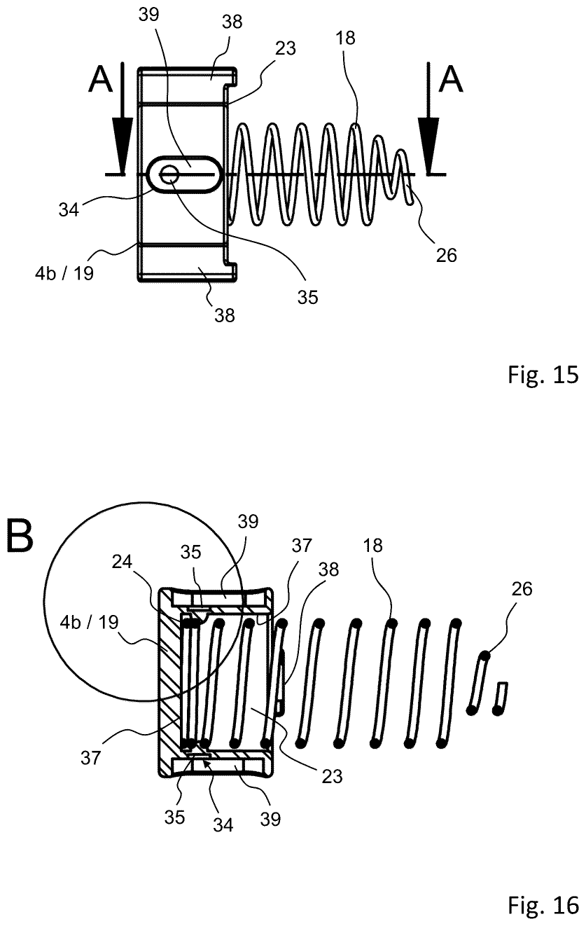

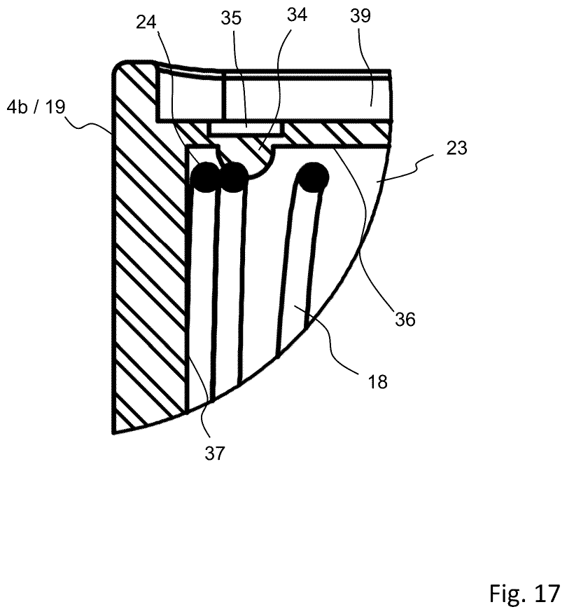

FIG. 15 illustrates a side view of coupling member 19 of FIG. 13 including coupling member 19 and spring member 18 that is form-fittingly connected by deforming blind hole 35 within recess 39 of deformation region 34. In addition, cut A-A for the sectional view of FIG. 16 is shown.

FIG. 16 illustrates a sectional side view of coupling member 19 of FIG. 15. It can be seen that at each opposite side recess 39 is arranged with respective blind hole 35 in deformation region 34. Blind hole 35 is deformed into receiving opening 23, that is, into the interior space of coupling member 19, whereby one protruding lug each engages with distal end portion 24 of spring member 18. Thereby, spring member 18 is form-fittingly and, where applicable, frictionally connected to coupling member 19.

FIG. 17 illustrates a side cutout view of coupling member 19 of FIG. 16 in the area of a deformation region with spring member 18 form-fittingly connected thereto. It can be seen that distal end portion 24 of spring member 18 abuts against end face 37 of receiving opening 23. The lug formed in deflection region 34 is readily visible, which rests on the outer circumference of a spring winding and form-fittingly fixes spring windings, for example, two spring windings 24 between end face 37 and the lug or deformation region 34, respectively.

### LIST OF REFERENCE NUMERALS

1 electric locking unit
2 locking cylinder
3 cylinder housing
4 locking member
4a cylinder cam
4b pressure member
5 dog
6 knob shaft
7 operating knob
8 coupling device
9 electric motor
10 shaft
11 worm shaft
12 drive electronics
13 radio signal receiver
14 knob shaft
15 operating knob
16a, 16b lock screw
17a, 17b circumferential groove
18 spring member
19 coupling member
20 spring retaining core
21 coupling element
22 coupling contour
23 receiving opening
24 distal end portion
25 support portion
26 proximal end portion
27 drilling protection member
28 threaded bore
29 latching groove
30 bumps
31 intermediate region
32 trough
33 lugs
34 deformation region
35 blind hole
36 inner wall
37 end face
38 cuboid protrusion
39 recess

What is claimed is:

1. An electric locking unit comprising a coupling device, the coupling device comprising an electric motor, a spring member, and a coupling member, the electric motor having a worm shaft with a helical winding, wherein the coupling member is mounted axially slidably in the direction of extension of the worm shaft and has a contour configured to mechanically couple with a locking member, and wherein the spring member is connected, at a distal end portion, to the coupling member and, at an opposite proximal end portion, is axially slidably coupled with the worm shaft of the electric motor to convert a rotation of the worm shaft into a linear motion of the proximal end portion of the spring member, wherein the worm shaft is idling when the spring member that is compressed or extended into a bias position reaches one of the two end positions of the locking cylinder in the coupled or decoupled state,
wherein the proximal end portion of the spring member has a reduced diameter over at least one winding wrap over the worm shaft, such that the spring member is able to engage with the worm shaft via this at least one winding wrap.

2. The electric locking unit according to claim 1, wherein the coupling member has a polygonal outer contour.

3. The electric locking unit according to claim 1, wherein the coupling member has a cylindrical outer contour, wherein a cuboid protrusion is arranged at the outer circumference.

4. The electric locking unit according to claim 3, wherein a pair of cuboid protrusions at the outer circumference of the cylindrical outer contour of the coupling member protrude in opposite directions from one another from the outer circumference.

5. The electric locking unit according to claim 1, wherein the coupling member comprises a spring retaining core and a coupling element, wherein the coupling element comprises a receiving opening for receiving a spring retaining core that is installed in the receiving opening in a rotationally fixed manner, and wherein the spring retaining core comprises a support portion protruding towards the worm shaft and the distal end portion of the spring member encloses the support portion with at least two winding wraps and is frictionally connected to the support portion.

6. The electric locking unit according to claim 1, wherein the coupling member comprises a receiving opening for receiving the distal end portion of the spring member, which abuts against a tubular wall delimiting the receiving opening, wherein the coupling member has at least one deformation region, where a deformation portion of the tubular wall is warped into the interior space of the coupling member and the distal end portion of the spring member received in the receiving opening is form-fittingly connected to the coupling member by means of the deformation region protruding into the interior space of the coupling member.

7. The electric locking unit according to claim 6, wherein the distal end portion of the spring member abuts against the end face delimiting the receiving opening and at least two winding wraps of the distal end portion of the spring member are disposed between the end face and the deformation portion.

8. The electric locking unit according to claim 1, wherein the spring member comprises a compression spring.

9. The electric locking unit according to claim 1, wherein the electric locking unit is configured as a locking cylinder comprising a cylinder housing, a cylinder cam rotatably mounted in the cylinder housing, and a knob shaft rotatably mounted in the cylinder housing, wherein the coupling device is configured within the knob shaft for mechanically coupling the knob shaft with the cylinder cam, and wherein drive electronics is connected to the coupling device for electronically coupling and decoupling the knob shaft and the cylinder cam.

10. An electric locking unit embodied as a locking cylinder comprising a cylinder housing, a cylinder cam rotatably mounted in the cylinder housing, a knob shaft rotatably mounted in the cylinder housing, and a coupling device, wherein the coupling device is disposed within the knob shaft and configured to mechanically couple the knob shaft with the cylinder cam and comprises an electric motor having a worm shaft with a helical winding, a spring member, and a coupling member, wherein the coupling member is mounted axially slidably in the direction of extension of the worm shaft and has a contour configured to mechanically couple with a locking member, and wherein the spring member is connected, at a distal end portion, to the coupling member and, at an opposite proximal end portion, is axially slidably coupled with the worm shaft of the electric motor to convert a rotation of the worm shaft into a linear motion of the proximal end portion of the spring member, wherein the worm shaft is idling when the spring member that is compressed or extended into a bias position reaches one of the two end positions of the locking cylinder in the coupled or decoupled state, wherein the coupling member has a polygonal outer contour or a cylindrical outer contour with a cuboid protrusion arranged at the outer circumference.

11. The electric locking unit according to claim 10, wherein a pair of cuboid protrusions at the outer circumference of the cylindrical outer contour of the coupling member protrude in opposite directions from one another from the outer circumference.

12. The electric locking unit according to claim 10, wherein a drilling protection member is disposed in the knob shaft on the side of the electric motor opposing the shaft.

13. The electric locking unit according to claim 10, wherein drive electronics is connected to the electric motor and configured to electronically couple and decouple the coupling member.
